(19) United States
(12) Patent Application Publication
(10) Pub. No.: US 2025/0233129 A1
(43) Pub. Date: Jul. 17, 2025

(54) CATHODE ACTIVE MATERIAL FOR LITHIUM SECONDARY BATTERY AND LITHIUM SECONDARY BATTERY INCLUDING THE SAME

(71) Applicant: SK ON CO., LTD., Seoul (KR)

(72) Inventors: Yae Seol NAM, Daejeon (KR); Chang Geun SON, Daejeon (KR); Ji Soo HAN, Daejeon (KR)

(21) Appl. No.: 19/018,242

(22) Filed: Jan. 13, 2025

(30) Foreign Application Priority Data
Jan. 15, 2024 (KR) 10-2024-0006066

(51) Int. Cl. H01M 4/36; H01M 4/02; H01M 4/525; H01M 4/58; H01M 10/052

(52) U.S. Cl. CPC H01M 4/364; H01M 4/525; H01M 4/5825; H01M 10/052; H01M 2004/021; H01M 2004/028

(57) ABSTRACT

A cathode active material for a lithium secondary battery includes first lithium metal phosphate particles, second lithium metal phosphate particles having an average particle diameter (D50) smaller than an average particle diameter (D50) of the first lithium metal phosphate particles and including manganese, and lithium-transition metal oxide particles having an average particle diameter (D50) larger than the average particle diameter (D50) of the first lithium metal phosphate particles and including nickel. A secondary battery include the cathode active material for a lithium secondary battery.

### CROSS-REFERENCE TO RELATED APPLICATION AND CLAIM OF PRIORITY

This patent document claims the priority and benefits of Korean Patent Application No. 10-2024-0006066 filed on Jan. 15, 2024, the entire disclosure of which is incorporated herein by reference.

### TECHNICAL FIELD

The disclosed technology relates to a cathode active material for a lithium secondary battery and a lithium secondary battery including the same.

### BACKGROUND

Secondary batteries are rechargeable batteries that can undergo repeated charging and discharging cycles. With the advancement of the information, communication, and display industries, secondary batteries are being widely used as power sources for mobile electronic devices such as camcorders, mobile phones, and laptop computers. In addition, battery packs, including secondary batteries, are being developed and applied as power sources for eco-friendly vehicles such as electric vehicles and hybrid vehicles.

Examples of the secondary battery include lithium secondary batteries, sodium secondary batteries, potassium secondary batteries, nickel-cadmium batteries, and nickel-hydrogen batteries. Lithium secondary batteries, among these secondary batteries, are being actively developed due to their high operating voltage, high energy density per unit weight, fast charging capability, and advantages in miniaturization.

### SUMMARY

In an aspect of the disclosed technology, there is provided a cathode active material for a lithium secondary battery having improved power and life-span properties.

In an aspect of the disclosed technology, there is provided a lithium secondary battery having improved power and life-span properties.

A cathode active material for a lithium secondary battery includes first lithium metal phosphate particles, second lithium metal phosphate particles having an average particle diameter (D50) smaller than an average particle diameter (D50) of the first lithium metal phosphate particles and including manganese, and lithium-transition metal oxide particles having an average particle diameter (D50) larger than the average particle diameter (D50) of the first lithium metal phosphate particles and including nickel.

In some embodiments, the first lithium metal phosphate particles may have a shape of a single particle.

In some embodiments, the second lithium metal phosphate particles may have a shape of a single particle.

In some embodiments, the lithium-transition metal oxide particles may have a shape of a single particle.

In some embodiments, the first lithium metal phosphate particles, the second lithium metal phosphate particles, and the lithium-transition metal oxide particles may all have a shape of a single particle. In some embodiments, only some of the first lithium metal phosphate particles, the second lithium metal phosphate particles, and the lithium-transition metal oxide particles have a shape of a single particle.

In some embodiments, the average particle diameter (D50) of the first lithium metal phosphate particles may be in a range from 0.5 μm to 2 μm.

In some embodiments, the average particle diameter (D50) of the second lithium metal phosphate particles may be in a range from 0.4 μm to 1.5 μm.

In some embodiments, the average particle diameter (D50) of the lithium-transition metal oxide particles may be in a range from 2 μm to 6 μm.

In some embodiments, a content of the first lithium metal phosphate particles may be in a range from 10 wt % to 50 wt % based on a total weight of the cathode active material for a lithium secondary battery.

In some embodiments, a content of the second lithium metal phosphate particles may be in a range from 10 wt % to 50 wt % based on a total weight of the cathode active material for a lithium secondary battery.

In some embodiments, a content of the lithium-transition metal oxide particles may be in a range from 5 wt % to 40 wt % based on a total weight of the cathode active material for a lithium secondary battery.

In some embodiments, the first lithium metal phosphate particles are represented by Chemical Formula 1

LiₐM1ₓP_{y}O_{4+z} [Chemical Formula 1]

In Chemical Formula 1, 0.9≤a≤1.2, 0.99≤x≤1.01, 0.9≤y≤1.2, −0.1≤z≤0.1, and M1 may include at least one selected from Fe, Co and Ni.

In some embodiments, the second lithium metal phosphate particles may be represented by Chemical Formula 2.

Li_{b}Mn_{c}Fe_{d}PₑO_{4+f} [Chemical Formula 2]

In Chemical Formula 2, 0.9≤b≤1.2, 0.4≤c≤1.0, 0.2≤d≤0.6, 0.9≤e≤1.2, and −0.1≤f≤0.1.

In some embodiments, the lithium-transition metal oxide particles may further include cobalt and manganese.

In some embodiments, a molar ratio of nickel based on the total molar number of nickel, cobalt and manganese included in the lithium-transition metal oxide particle may be 0.8 or more.

A lithium secondary battery includes a cathode including the above-described cathode active material for a lithium secondary battery, and an anode facing the cathode.

The cathode active material implemented based on some embodiments of the disclosed technology can improve the power output, low-temperature properties and life-span properties of lithium secondary batteries.

In some embodiments of the disclosed technology, the cathode active material including a mixture of particles with different average particle diameters (D50) can improve the durability, life-span properties and capacity properties of lithium secondary batteries.

In some embodiments of the disclosed technology, impact resistance and stability of the cathode may be improved.

The cathode active material for a lithium secondary battery and the lithium secondary battery including the cathode active material based on some embodiments of the disclosed technology may be widely applied in green technology fields such as an electric vehicle, a battery charging station, a solar power generation, a wind power generation, etc., using a battery, etc. The cathode active material for a lithium secondary battery and the lithium secondary battery based on some embodiments of the disclosed technology may be used for eco-friendly electric vehicles and hybrid vehicles to prevent a climate change by suppressing air pollution and greenhouse gas emissions, etc.

### BRIEF DESCRIPTION OF THE DRAWINGS

FIG. 1 is a schematic cross-sectional view illustrating a cathode based on some example embodiments.

FIG. 2 is a schematic plan view illustrating a lithium secondary battery based on some example embodiments.

FIG. 3 is a cross-sectional view illustrating a lithium secondary battery based on some example embodiments.

### DETAILED DESCRIPTION OF THE EMBODIMENTS

Section headings are used in the present document only for ease of understanding and do not limit scope of the embodiments to the section in which they are described.

Lithium metal phosphates may be used as a cathode active material for lithium secondary batteries. However, the low ion conductivity and energy density of lithium metal phosphates may lead to a reduction in the output power, low-temperature performance, and electrode density of lithium secondary batteries.

The disclosed technology can be implemented in some embodiments disclosed technology can address these issues by providing a cathode active material for a lithium secondary battery including a lithium metal phosphate particle. Additionally, the disclosed technology can be implemented in some embodiments to provide a secondary battery such as a lithium secondary battery including the cathode active material.

Hereinafter, some embodiments of the disclosed technology will be described in detail. It should be noted, however, that the embodiments discussed below are provided as examples, and the disclosed technology is not limited to the specific embodiments.

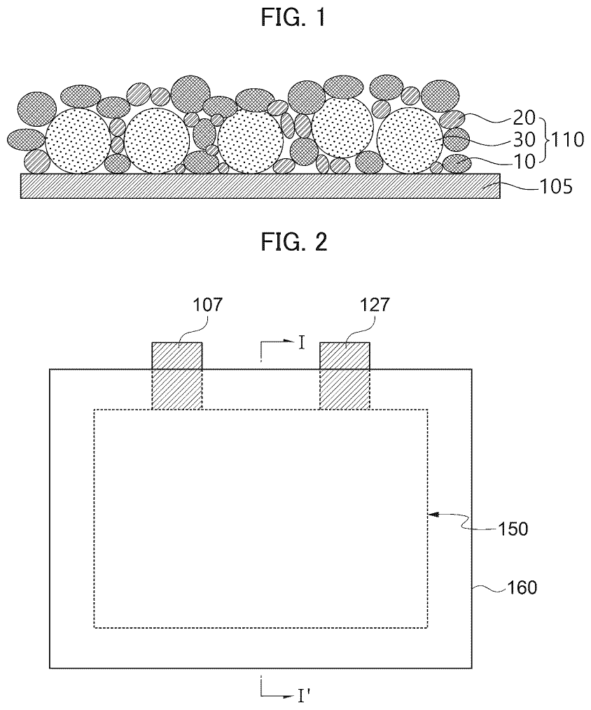

FIG. 1 is a schematic cross-sectional view illustrating a cathode based on some example embodiments.

Referring to FIG. 1, a cathode active material layer 110 including a cathode active material may be formed on at least one surface of a cathode current collector 105.

The cathode current collector 105 may include stainless steel, nickel, aluminum, titanium, copper, or an alloy thereof. The cathode current collector 105 may also include aluminum or stainless steel surface-treated with carbon, nickel, titanium, copper or silver. For example, a thickness of the cathode current collector 105 may be in a range from 5 μm to 50 μm. In some example embodiments, the cathode active material may include a first lithium

metal phosphate particles 10, a second lithium metal phosphate particle 20 including manganese, and a lithium-transition metal oxide particle 30 including nickel. As the three particles 10, 20 and 30 are mixed and used together, the power output, low-temperature and life-span properties of the cathode active material and lithium secondary batteries may be improved.

For example, the stability and life-span properties of the cathode active material and lithium secondary batteries may be improved by the first lithium metal phosphate particle 10, the low-temperature performance may be improved by the second lithium metal phosphate particles 20, and the power output properties and capacity may be improved by the lithium-transition metal oxide particle 30.

In some embodiments, the first lithium metal phosphate particle 10 may have an olivine structure, and may include a crystal structure represented by Chemical Formula 1.

LiₐM1ₓP_{y}O_{4+z} [Chemical Formula 1]

In Chemical Formula 1, 0.9≤a≤1.2, 0.99≤x≤1.01, 0.9≤y≤1.2, −0.1≤z≤0.1, and M1 may include at least one selected from the group consisting of Fe, Co and Ni.

In an embodiment, the first lithium metal phosphate particle 10 may include LiFePO₄.

In some embodiments, the second lithium metal phosphate particle 20 may have an olivine structure including manganese and iron, and may include a crystal structure represented by the following Chemical Formula 2.

Li_{b}Mn_{c}Fe_{d}PₑO_{4+f} [Chemical Formula 2]

In Chemical Formula 2, 0.9≤b≤1.2, 0.4≤c≤1.0, 0.25≤d≤0.6, 0.9≤e≤1.2, and −0.1≤f≤0.1.

In some embodiments, the lithium-transition metal oxide particle 30 may include a lithium-nickel (Ni) metal oxide particle. The lithium-nickel metal oxide may further include at least one of cobalt (Co), manganese (Mn), or aluminum (Al).

In some embodiments, the lithium-nickel metal oxide particle may include a layered structure or a crystal structure represented by the following Chemical Formula 3.

LiₓNiₐM2_{b}O_{2+z} [Chemical Formula 3]

In the chemical formula 3, 0.9≤x≤1.2, 0.6≤a≤0.99, 0.01≤b≤0.4, and −0.5≤z≤0.1. As described above, M2 may include Co, Mn and/or Al.

The chemical structures represented by Chemical Formulae 1 to 3 represent bonding relationships included in the crystal structures of the first lithium metal phosphate particle 10, the second lithium metal phosphate particle 20 and the lithium-transition metal oxide particles 30, respectively, and do not exclude other additional elements. For example, in Chemical Formula 1, M1 may include Fe, Co and/or Ni, and Fe, Co and/or Ni may serve as the main (or primary) active element of the first lithium metal phosphate particle 10. For example, in Chemical Formula 3, M2 includes Co and/or Mn, and Co and/or Mn, which may serve as the main active element of the cathode active material together with Ni. Chemical Formulae 1 to 3 are provided to express the bonding relationships of the main active element and should be understood as encompassing the introduction and substitution of additional elements.

In an embodiment, an auxiliary element may be further included in addition to the main active element to enhance the chemical stability of the cathode active material or the crystal structure. The auxiliary element may be incorporated in the layered structure/crystal structure to form a bond and should be understood as falling within the scope of the chemical structure represented by Chemical Formulae 1 to 3.

The auxiliary element may include at least one selected from the group consisting of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al which may contribute to capacity/power activity of the cathode active material together with Co or Mn. For example, the lithium-transition metal oxide particle 30 or the lithium-nickel metal oxide particle may include a layered structure or a crystal structure represented by Chemical Formula 3-1 below.

LiₓNiₐM1_{b1}M_{b2}O_{2+z} [Chemical Formula 3-1]

In Chemical Formula 3-1, M1 may include Co, Mn and/or Al. M2 may include the above-described auxiliary element. In Chemical formula 3-1, 0.9≤x≤1.2, 0.6≤a≤0.99, 0.01≤b1+b2≤0.4, and −0.5≤z≤0.1.

At least one of the first lithium metal phosphate particle 10, the second lithium metal phosphate particle 20, or the lithium-transition metal oxide particle 30 may further include a coating element or a doping element. For example, elements substantially the same as or similar to the above-describe auxiliary elements may be used as the coating element or the doping element. For example, the above-mentioned elements may be used alone or in a combination of two or more therefrom as the coating element or the doping element.

The coating element or doping element may be present on a surface of the first lithium metal phosphate particle 10, the second lithium metal phosphate particle 20 and/or the lithium-transition metal oxide particle 30, or may penetrate through the surface of the first lithium metal phosphate particle 10, the second lithium metal phosphate particle 20 and/or the lithium-transition metal oxide particle 30 to be included in the bonding structure represented by Chemical Formulae 1 to 3 or Chemical Formula 3-1.

In some embodiments, the lithium-nickel metal oxide particle may include a nickel-cobalt-manganese (NCM)-based lithium oxide. In this case, an NCM-based lithium oxide having an increased nickel content may be used.

Ni may be provided as a transition metal related to the power output and capacity of lithium secondary batteries. Thus, a high-content Ni (High-Ni) composition may be employed in the cathode active material, so that a high-capacity cathode and a high-capacity lithium secondary battery may be provided.

However, as the content of Ni increases, the long-term storage stability and life-span stability of the cathode or the secondary battery may be relatively degraded, and side reactions with an electrolyte may also increase. However, the disclosed technology can be implemented in some example embodiments to improve the life-span stability and capacity retention properties by using Mn, while maintaining an electrical conductivity by including Co.

The content of Ni in the lithium-transition metal oxide particle 30 (e.g., a molar ratio of nickel included in the lithium-transition metal oxide particle 30 based on the total molar number of metals excluding lithium in the lithium-transition metal oxide particle 30) may be 0.5 or more, 0.6 or more, 0.7 or more, 0.8 or more, 0.9 or more, or 0.95 or more. In some embodiments, the content of Ni may be in a range from 0.8 to 0.98, from 0.82 to 0.98, from 0.83 to 0.98, from 0.84 to 0.98, from 0.85 to 0.98, from 0.88 to 0.98, or from 0.9 to 0.98. When the Ni content is 0.8 or more, the capacity and power properties may be improved.

One material parameter for a material formed of particles is the particle size distribution parameter DX of the particles in the material where DX represents that X % of particles in the material has a particle diameter or size less than DX. For example, D80 represents a material in which 80% of the particles has a size less than D80 and D30 represents a material in which 30% of the particles has a size less than D30. The “average particle diameter (D50)” in the examples below refers to a particle diameter at which a volume cumulative percentage reaches 50% in a particle size distribution by the volume, i.e., 50% of particles by volume is a particle size less than D50.

An average particle diameter (D50) of the second lithium metal phosphate particles 20 may be smaller than an average particle diameter (D50) of the first lithium metal phosphate particles 10, and an average particle diameter (D50) of the lithium-transition metal oxide particles 30 may be larger than the average particle diameter (D50) of the first lithium metal phosphate particles 10. The mixing of the particles 10, 20 and 30 with different average particle diameters

(D50) based on some embodiments of the disclosed technology can improve durability, electrode density, life-span properties and capacity properties.

For example, the average particle diameter (D50) of lithium-transition metal oxide particles 30 may be provided as large-diameter particles, thereby improving the capacity and power properties.

For example, the average particle diameter (D50) of the second lithium metal phosphate particles 20 may be provided as small-diameter particles, thereby improving the life-span properties.

In some embodiments, the average particle diameter (D50) of the first lithium metal phosphate particles 10 may be in a range from 0.5 μm to 2 μm, in an embodiment, from 0.62 μm to 1.7 μm. In the above range, the deterioration of low-temperature performance and power properties may be suppressed, while further improving the life-span properties of the secondary battery.

In some embodiments, the average particle diameter (D50) of the second lithium metal phosphate particles 20 may be in a range from 0.4 μm to 1.5 μm, in an embodiment, from 0.61 μm to 1.2 μm. In the above range, the deterioration of the life-span and power properties may be suppressed, while further improving low-temperature performance of the secondary battery.

In some embodiments, the average particle diameter (D50) of the lithium-transition metal oxide particles 30 may be in a range from 2 μm to 6 μm, in an embodiment, from 3.5 μm to 4.0 μm. In the above range, the deterioration of the life-span properties and the low temperature performance may be suppressed, while further improving the power properties of the secondary battery.

In some embodiments, the first lithium metal phosphate particle 10 may have a shape of a single particle. Accordingly, the impact resistance and stability of the cathode may be improved.

In some embodiments, the second lithium metal phosphate particle 20 may have a shape of a single particle. Accordingly, the mechanical stability of the second lithium metal phosphate particles 20 having a relatively small average particle diameter (D50) may be improved.

In some embodiments, the lithium-transition metal oxide particle 30 may have a shape of a single particle. Accordingly, the durability of the lithium-transition metal oxide particles 30 having a relatively large average particle diameter (D50) may be improved, and thus life-span properties may be improved.

In some embodiments, the first lithium metal phosphate particle 10, the second lithium metal phosphate particle 20 and/or the lithium-transition metal oxide particles 30 may have a shape of a single particle.

In an embodiment, the first lithium metal phosphate particle 10, the second lithium metal phosphate particle 20 and the lithium-transition metal oxide particle 30 may have a shape of a single particle. Accordingly, mechanical stability of the cathode and the life-span properties of the secondary battery may be further improved.

In some embodiments, the term “a shape of a single particle” can be used to indicate a single particle form or a single particle state. In some embodiments, the term “a shape of a single particle” can be used to indicate particles that are not a secondary particle formed by the agglomeration of a plurality of primary particles. For example, in the first lithium metal phosphate particle 10, the second lithium metal phosphate particle 20, and/or the lithium-transition metal oxide particle 30, “a shape of a single particle” can refer to particles that are not a secondary particle structure composed of aggregated or assembled primary particles (e.g., more than 10, 20 or more, 30 or more, 40 or more, 50 or more primary particles).

In some embodiments, the term “a shape of a single particle” does not exclude a form in which, e.g., 2 to 10 single particles are simply adjacent to or in contact with each other.

For example, the first lithium metal phosphate particle 10, the second lithium metal phosphate particle 20 and/or the lithium-transition metal oxide particles 30 may have a granular or spherical single particle form.

In some examples, a content of the first lithium metal phosphate particles 10 may be in a range from 10 weight percent (wt %) to 50 wt % based on a total weight of the cathode active material, in an embodiment, from 30 wt % to 40 wt %. In the above range, deterioration of low-temperature performance and power may be suppressed while further improving the life-span properties of the secondary battery.

In some embodiments, a content of the second lithium metal phosphate particles 20 may be in a range from 10 wt % to 50 wt % based on the total weight of the cathode active material, in an embodiment, from 30 wt % to 40 wt %. In the above range, deterioration of the life-span properties and power properties may be suppressed while further improving low-temperature performance of the secondary battery.

In some embodiments, a content of the lithium-transition metal oxide particles 30 may be in a range from 5 wt % to 40 wt % based on the total weight of the cathode active material, in an embodiment, from 10 wt % to 40 wt %. In the above range, degradation of the life-span properties and low temperature performance may be suppressed while further improving the power properties of the secondary battery.

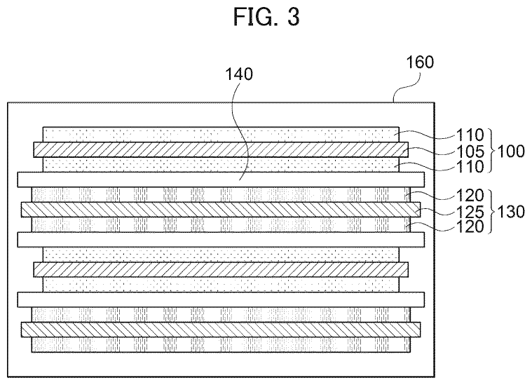

FIGS. 2 and 3 are a schematic plan view and a schematic cross-sectional view, respectively, illustrating a lithium secondary battery based on some example embodiments. For example, FIG. 3 is a cross-sectional view taken along a line I-I′ of FIG. 2 in a thickness direction.

Referring to FIGS. 2 and 3, the lithium secondary battery may include a cathode 100 including the above-described cathode active material and an anode 130 facing the cathode 100.

The cathode 100 may include a cathode active material layer 110 formed by coating the cathode active material on at least one surface of a cathode current collector 105.

The cathode active material may include a plurality of the first lithium metal phosphate particles 10, a plurality of the second lithium metal phosphate particles 20, and a plurality of the lithium-transition metal oxide particles 30. For example, a total content of the first lithium metal phosphate particles 10, the second lithium metal phosphate particles 20 and the lithium-transition metal oxide particles 30 based on the total weight of the cathode active material may be 50 wt % or more. In some embodiments, the total content of the first lithium metal phosphate particles 10, the second lithium metal phosphate particles 20 and the lithium-transition metal oxide particles 30 based on the total weight of the cathode active material may be 60 wt % or more, 70 wt % or more, 80 wt % or more, or 90 wt % or more.

In an embodiment, the cathode active material may substantially consist of the first lithium metal phosphate particles 10, the second lithium metal phosphate particles 20 and lithium-transition metal oxide particles 30.

A cathode slurry may be prepared by mixing the cathode active material in a solvent. The cathode slurry may be coated on at least one surface of the cathode current collector 105, and then dried and pressed to form the cathode active material layer 110. The coating may include a gravure coating, a slot die coating, a multi-layered simultaneous die coating, an imprinting, a doctor blade coating, a dip coating, a bar coating, a casting, or the like. The cathode active material layer 110 may further include a binder, and may optionally further include a conductive material, a thickener, or the like.

N-methyl-2-pyrrolidone (NMP), dimethylformamide, dimethylacetamide, N,N-dimethylaminopropylamine, ethylene oxide, tetrahydrofuran, or the like, may be used as the solvent.

The binder may include polyvinylidene fluoride (PVDF), poly (vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR), or the like. These may be used alone or in a combination of two or more therefrom.

In an embodiment, a PVDF-based binder may be used as the cathode binder. In this case, an amount of the binder for forming the cathode active material layer 110 may be reduced and an amount of the cathode active material may be relatively increased. Accordingly, the power and capacity properties of the secondary battery may be improved.

The conductive material may be added to improve a conductivity of the cathode active material layer 110 and/or a mobility of lithium ions or electrons. For example, the conductive material may include a carbon-based conductive material such as graphite, carbon black (e.g., Denka Black), acetylene black, Ketjen Black, graphene, a vapor-grown carbon fiber (VGCF) or a carbon fiber, and/or a metal-based conductive material including tin, tin oxide, titanium oxide, a perovskite material such as LaSrCoO₃ or LaSrMnO₃, etc. These may be used alone or in a combination of two or more therefrom.

The cathode slurry may further include a thickener and/or a dispersive agent. In an embodiment, the cathode slurry may include the thickener such as carboxymethyl cellulose (CMC).

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with a conductive metal, or the like. These may be used alone or in a combination of two or more therefrom. For example, a thickness of the anode current collector 125 may be in a range from 5 μm to 50 μm.

The anode active material layer 120 may include an anode active material. A material capable of adsorbing and desorbing the lithium ions may be used as the anode active material. For example, the anode active material may include a carbon-based material such as a crystalline carbon, an amorphous carbon, a carbon composite or carbon fiber; a lithium metal; a lithium alloy; a silicon (Si)-containing material or a tin (Sn)-containing material, or the like. These may be used alone or in a combination of two or more therefrom.

The amorphous carbon may include hard carbon, soft carbon, coke, a mesocarbon microbead (MCMB), a mesophase pitch-based carbon fiber (MPCF), or the like.

The crystalline carbon may include graphite-based carbon such as natural graphite, artificial graphite, a graphitized coke, a graphitized MCMB, a graphitized MPCF, or the like.

The lithium metal may include a pure lithium metal and/or a lithium metal having a protective layer formed thereon for suppressing a dendrite growth. In an embodiment, a lithium metal-containing layer deposited or coated on the anode current collector 125 may be used as the anode active material layer 120. In an embodiment, a lithium thin film may be used as the anode active material layer 120.

Elements included in the lithium alloy may include aluminum, zinc, bismuth, cadmium, antimony, silicon, lead, tin, gallium, indium, or the like. These may be used alone or in a combination of two or more therefrom.

The silicon-containing material may provide increased capacity properties. The silicon-containing material may include Si, SiOx (0<x<2), a metal-doped SiOx (0<x<2), a silicon-carbon composite, or the like.

The metal may include lithium and/or magnesium, and the metal-doped SiOx (0<x<2) may include a metal silicate.

The anode active material may be mixed in a solvent to prepare an anode slurry. The anode slurry may be coated/deposited on the anode current collector 125, and them dried and pressed to obtain the anode active material layer 120. The coating may include a gravure coating, a slot die coating, a multi-layered simultaneous die coating, an imprinting, a doctor blade coating, a dip coating, a bar coating, a casting, or the like. The anode active material layer 120 may further include a binder and optionally further include a conductive material, a thickener, etc.

The solvent included in the anode slurry may include water, pure water, deionized water, distilled water, ethanol, isopropanol, methanol, acetone, n-propanol, t-butanol, etc. These may be used alone or in combination of two or more therefrom.

The above-described materials used in the fabrication of the cathode 100 may also be used as the binder, the conductive material and thickener.

In some embodiments, a styrene-butadiene rubber (SBR)-based binder, carboxymethyl cellulose (CMC), a polyacrylic acid-based binder, a poly(3,4-ethylenedioxythiophene (PEDOT)-based binder, etc., may be used as the anode binder. These may be used alone or in a combination of two or more therefrom.

In some example embodiments, a separator 140 may be interposed between the cathode 100 and the anode 130. The separator 140 may be included to prevent an electrical short-circuiting between the cathode 100 and the anode 130 while allowing an ion flow. For example, a thickness of the separator may be in a range from 10 μm to 20 μm.

For example, the separator 140 may include a porous polymer film or a porous non-woven fabric.

The porous polymer film may include a polyolefin-based polymer such as an ethylene polymer, a propylene polymer, an ethylene/butene copolymer, an ethylene/hexene copolymer, an ethylene/methacrylate copolymer, etc. These may be used alone or in a combination of two or more therefrom.

The porous non-woven fabric may include a high melting point glass fiber, a polyethylene terephthalate fiber, etc.

The separator 140 may include a ceramic-based material. For example, inorganic particles may be coated on the polymer film or dispersed in the polymer film to improve a heat resistance.

The separator 140 may have a single-layered or a multi-layered structure including the polymer film and/or the non-woven fabric as described above.

In some example embodiments, an electrode cell may be defined by the cathode 100, the anode 130 and the separator 140, and a plurality of the electrode cells may be stacked to form an electrode assembly 150 having, e.g., a jelly roll shape. For example, the electrode assembly 150 may be formed by winding, stacking, z-folding, stack-folding, etc., of the separator 140. The electrode assembly 150 may be accommodated together with an electrolyte solution

in a case 160 to define the lithium secondary battery. In some example embodiments, a non-aqueous electrolyte solution may be used as the electrolyte solution.

The non-aqueous electrolyte solution may include a lithium salt serving as an electrolyte and an organic solvent. The lithium salt may be represented by, e.g., Li⁺X⁻, and examples of an anion X⁻ may include F⁻, Cl⁻, Br⁻, I⁻, NO₃⁻, N(CN)₂, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), butylene carbonate, diethyl carbonate (DEC), dimethyl carbonate (DMC), ethylmethyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethylpropionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, propylene sulfite, etc. These may be used alone or in a combination of two or more therefrom.

The non-aqueous electrolyte solution may further include an additive. The additive may include, e.g., a cyclic carbonate-based compound, a fluorine-substituted carbonate-based compound, a sultone-based compound, a cyclic sulfate-based compound, a cyclic sulfite-based compound, a phosphate-based compound, a borate-based compound, etc. These may be used alone or in a combination of two or more therefrom.

The cyclic carbonate-based compound may include vinylene carbonate (VC), vinyl ethylene carbonate (VEC), etc.

The fluorine-substituted carbonate-based compound may include fluoroethylene carbonate (FEC).

The sultone-based compound may include 1,3-propane sultone, 1,3-propene sultone, 1,4-butane sultone, etc.

The cyclic sulfate-based compound may include 1,2-ethylene sulfate, 1,2-propylene sulfate, etc.

The cyclic sulfite-based compound may include ethylene sulfite, butylene sulfite, etc.

The phosphate-based compound may include lithium difluoro bis-oxalato phosphate, lithium difluoro phosphate, etc.

The borate-based compound may include lithium bis(oxalate) borate.

In some embodiments, a solid electrolyte may be used instead of the non-aqueous electrolyte solution. In this case, the lithium secondary battery may be manufactured in the form of an all-solid-state battery. Additionally, a solid electrolyte layer may be disposed between the cathode 100 and the anode 130 instead of the separator 140.

The solid electrolyte may include a sulfide-based electrolyte. Non-limiting examples of the sulfide-based electrolyte include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m and n are positive numbers, and Z represents Ge, Zn or Ga), Li₂S—GeS₂, Li₂S—SiS₂—Li₃PO₄, Li₂S—SiS₂—LiₚMO_{q}, (p and q positive numbers, and M represents P, Si, Ge, B, Al, Ga or In), Li_{7-X}PS₆₋ₓClₓ (0<x<2), Li₇₋ₓPS₆₋ₓBrₓ (0≤x≤2), Li₇₋ₓPS₆₋ₓIₓ (0≤x≤2), etc. These may be used alone or in a combination of two or more therefrom.

In an embodiment, the solid electrolyte may include an oxide-based amorphous solid electrolyte such as Li₂O—B₂O₃—P₂O₅, Li₂O—SiO₂, Li₂O—B₂O₃, Li₂O—B₂O₃—ZnO, etc.

As illustrated in FIGS. 2 and 3, electrode tabs (a cathode tab and an anode tab) may protrude from the cathode current collector 105 and the anode electrode current collector 125 included in each electrode cell to one side of the case 160. The electrode tabs may be welded together with the one side of the case 160 to form an electrode lead (a cathode lead 107 and an anode lead 127) extending or exposed to an outside of the case 160.

The lithium secondary battery may be manufactured in, e.g., a cylindrical shape using a can, a prismatic shape, a pouch shape or a coin shape.

Hereinafter, embodiments of the disclosed technology are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Preparation Example 1—First Lithium Metal Phosphate Particle

Lithium carbonate, iron phosphate, and sodium hexametaphosphate as a dispersive agent were added to distilled water, and particles were mixed and pulverized using a ball mill to form a mixed solution containing LiFePO₄.

The mixed solution containing LiFePO₄ was dried using a spray dryer having a micro-nozzle shape.

The dried powder was calcined at a temperature in a range from about 600° C. to 750° C. for about 5 to 12 hours under a nitrogen atmosphere, and then a de-iron process was performed to obtain LiFePO₄ particles having a single-particle shape.

The LiFePO₄ particles were pulverized and classified using a ball mill to manufacture first lithium metal phosphate particles (LFP) having a single-particle shape and having an average particle diameter (D50) as shown in Table 1.

### Preparation Example 2—Second Lithium Metal Phosphate Particle

MnO, H₃PO₄, Fe₃O₄ and Li₂CO₃ were mixed using a ball mill. A first calcination of the mixture was performed at 450° C. for 4 hours under an argon (Ar) atmosphere, and then a second calcination was performed at 600° C. for 6 hours to obtain LiMn_{0.6}Fe_{0.4}PO₄ particles having a single particle shape.

The LiMn_{0.6}Fe_{0.4}PO₄ single particles were pulverized and classified using a ball mill to obtain second lithium metal phosphate particles having a single particle shape and having an average particle diameter (D50) as shown in Table 1.

### Preparation Example 3—Lithium-Transition Metal Oxide Particle

NiSO₄, CoSO₄ and MnSO₄ were added and mixed in a molar ratio of 0.8:0.1:0.1, respectively, to distilled water bubbled with N₂ for 24 hours to remove internal dissolved oxygen to prepare a mixture. The mixture was put into a reactor at 55° C., and a coprecipitation reaction was performed for 36 hours using NaOH and NH₃H₂O as a precipitating agent and a chelating agent to obtain Ni_{0.8}Co_{0.1}Mn_{0.1}(OH)₂ as a transition metal precursor. The transition metal precursor was dried at 80° C. for 12 hours, and then re-dried at 110° C. for 12 hours.

Lithium hydroxide and the transition metal precursor were added to a dry high-speed mixer at a ratio of 1.05:1 and uniformly mixed for 5 minutes. The mixture was placed in a calcination furnace under an oxygen atmosphere, heated to 1,000° C. at a ramping rate of 2° C./min, maintained at 1,000° C. for 5 hours, and naturally cooled to 900° C. and maintained for 5 hours. Oxygen was continuously passed at a flow rate of 10 mL/min during the heating and calcination. After the calcination, natural cooling to room temperature was performed, and lithium-transition metal oxide particles (LiNi_{0.8}Co_{0.1}Mn_{0.1}O₂) having a single particle shape and having an average particle diameter (D50) as shown in Table 1 were obtained by pulverization and classification.

### Examples 1 to 21, and Comparative Examples 7 to 9

The fir lithium metal phosphate particles, the second lithium metal phosphate particles, and the lithium-transition metal oxide particles having the average particle diameters (D50) as shown in Table 1 were manufactured according to Preparation Examples 1 to 3, and then mixed to have contents of Table 1 based on a total weight of a cathode active material to be used as the cathode active material.

The cathode active material, Denka Black as a conductive material, and PVDF as a binder were mixed in a mass ratio of 93:5:2, respectively, to prepare a cathode slurry. The cathode slurry was coated on an aluminum current collector, dried, and pressed to form a cathode including a cathode active material layer formed thereon.

A lithium metal was used as an anode active material.

The cathode and the anode manufactured as described above were notched into circular shapes having diameters of Φ14 and Φ16, respectively, and a separator (polyethylene, thickness: 13 μm) notched into Φ19 was interposed between the cathode and the anode to form an electrode cell. ΦN (N is a positive number) represents a circle having a diameter of N mm.

The electrode cell was placed in a coin cell outer case having a diameter of 20 mm and a height of 1.6 mm (CR2016), and an electrolyte solution was injected and o assembled, and an aging was performed for more than 12 hours so that the electrolyte solution impregnated an inside of the electrode.

A 1M LiPF₆ solution prepared using a mixed solvent of EC/EMC (30/70; volume ratio) was used as the electrolyte solution. The secondary battery manufactured as described above was subjected to a formation charge-discharge (charge condition: CC-CV 0.1 C 3.8V 0.05 C CUT-OFF, discharge condition: CC 0.1 C 2.5V CUT-OFF).

### Example 22

NiSO₄, CoSO₄ and MnSO₄ were added and mixed in a molar ratio of 0.8:0.1:0.1, respectively, to distilled water bubbled with N₂ for 24 hours to remove internal dissolved oxygen to prepare a mixture. The mixture was added to a reactor at 55° C., and a coprecipitation reaction was performed for 36 hours using NaOH and NH₃H₂O as a precipitating agent and a chelating agent to obtain Ni_{0.8}Co_{0.1}Mn_{0.1}(OH)₂ as a transition metal precursor. The transition metal precursor was dried at 80° C. for 12 hours, and then re-dried at 110° C. for 12 hours.

Lithium hydroxide and the transition metal precursor were added to a dry high-speed mixer in a ratio of 1.05:1 and uniformly mixed for 5 minutes. The mixture was placed in an oxygen atmosphere calcination furnace, heated to 850° C. at a ramping rate of 2° C./min, maintained at 850° C. for 5 hours, and naturally cooled to 750° C. and maintained for 5 hours. During the heating and calcination, oxygen was continuously passed at a flow rate of 10 mL/min. After the calcination, natural cooling was performed to room temperature, and lithium-transition metal oxide particles (LiNi_{0.8}Co_{0.1}Mn_{0.1}O₂) having a secondary particle shape and having an average particle diameter (D50) as shown in Table 1 were obtained by pulverization and classification.

A lithium secondary battery was manufactured by the same method as that in Example 1, except that the lithium-transition metal oxide particles having the secondary particle shape were used.

### Comparative Example 1

A lithium secondary battery was manufactured by the same method as that in Example 1, except that the first lithium metal phosphate particles of Preparation Example 1 were only used as the cathode active material.

### Comparative Example 2

A lithium secondary battery was manufactured by the same method as that in Example 1, except that the second lithium metal phosphate particles of Preparation Example 2 were only used as the cathode active material.

### Comparative Example 3

A lithium secondary battery was manufactured by the same method as that in Example 1, except that the lithium-transition metal oxide particles of Preparation Example 3 were only used as the cathode active material.

### Comparative Example 4

A lithium secondary battery was manufactured by the same method as that in Example 1, except that the first lithium metal phosphate particles and the second lithium metal phosphate particles were mixed to have contents of Table 1 based on the total weight of the cathode active material and used as the cathode active material.

### Comparative Example 5

A lithium secondary battery was manufactured by the same method as that in Example 1, except that the first lithium metal phosphate particles and the lithium-transition metal oxide particles were mixed to have contents of Table 1 based on the total weight of the cathode active material and used as the cathode active material.

### Comparative Example 6

A lithium secondary battery was manufactured by the same method as that in Example 1, except that the second lithium metal phosphate particles and the lithium-transition metal oxide particles were mixed to have contents of Table 1 based on the total weight of the cathode active material and used as the cathode active material.

### Experimental Example

### (1) Measurement of Average Particle Diameter (D50)

Average particle diameters (D50) of the first lithium metal phosphate particles, the second lithium metal phosphate particles and the lithium-transition metal oxide particles used in the above-described Examples and Comparative Examples were measured using a laser particle size analyzer (S3500 bluewave, Microtrac Co.).
Measurement condition: Circulation rate 65 mL/sec
Measurement time: 10 to 30 seconds
   (2) Measurement of ratio of 1.5 C, 2.0 C, 2.5 C and 3.0 C discharge capacities to ⅓C discharge capacity

The lithium secondary batteries manufactured according to the above-described Examples and Comparative Examples were charged (CC-CV 0.5 C 3.65V 0.05 C CUT-OFF) and discharged (CC ⅓ C 2.5V CUT-OFF) at room temperature (25° C.), and then a discharge capacity was measured. The measured discharge capacity was evaluated as a 1/3 C discharge capacity.

The lithium secondary batteries manufactured according to the above-described Examples and Comparative Examples were charged (CC-CV 0.5 C 3.65V 0.05 C CUT-OFF) and discharged (CC 1.5 C 2.5V CUT-OFF) at room temperature (25° C.), and then the discharge capacity was measured. The measured discharge capacity was evaluated as a 1.5 C discharge capacity.

The lithium secondary batteries manufactured according to the above-described Examples and Comparative Examples were charged (CC-CV 0.5 C 3.65V 0.05 C CUT-OFF) and discharged (CC 2.0 C 2.5V CUT-OFF) at room temperature (25° C.), and then a discharge capacity was measured. The measured discharge capacity was evaluated as a 2.0 C discharge capacity.

The lithium secondary batteries manufactured according to the above-described Examples and Comparative Examples were charged (CC-CV 0.5 C 3.65V 0.05 C CUT-OFF) and discharged (CC 2.5 C 2.5V CUT-OFF) at room temperature (25° C.), and then a discharge capacity was measured. The measured discharge capacity was evaluated as a 2.5 C discharge capacity.

The lithium secondary batteries manufactured according to the above-described Examples and Comparative Examples were charged (CC-CV 0.5 C 3.65V 0.05 C CUT-OFF) and discharged (CC 3.0 C 2.5V CUT-OFF) at room temperature (25° C.), and then a discharge capacity was measured. The measured discharge capacity was evaluated as a 3.0 C discharge capacity.

The 1.5 C discharge capacity was expressed as a percentage relative to the ⅓ C discharge capacity to calculate a 1.5 C discharge capacity ratio (%).

The 2.0 C discharge capacity was expressed as a percentage relative to the ⅓ C discharge capacity to calculate a 2.0 C discharge capacity ratio (%).

The 2.5 C discharge capacity was expressed as a percentage relative to the ⅓ C discharge capacity to calculate a 2.5 C discharge capacity ratio (%).

The 3.0 C discharge capacity was expressed as a percentage relative to the ⅓ C discharge capacity to calculate a 3.0 C discharge capacity ratio (%).

### (3) Evaluation on Low-Temperature Power Property

The lithium secondary batteries manufactured according to the above-described Examples and Comparative Examples were charged (CC-CV 0.5 C 3.65V 0.05 C CUT-OFF) and discharged (CC 0.1 C 2.5V CUT-OFF) at room temperature (25° C.), and then a discharge capacity was measured. The measured discharge capacity was evaluated as a room-temperature discharge capacity.

The lithium secondary batteries manufactured according to the above-described Examples and Comparative Examples were charged (CC-CV 0.5 C 3.65V 0.05 C CUT-OFF) and discharged (CC 0.1 C 2.5V CUT-OFF) at −10° C., and then a discharge capacity was measured. The measured discharge capacity was evaluated as a −10° C. low-temperature discharge capacity.

The −10° C. low-temperature discharge capacity was expressed as a percentage relative to the room-temperature discharge capacity to calculate a −10° C. low-temperature power property (%).

The lithium secondary batteries manufactured according to the above-described Examples and Comparative Examples were charged (CC-CV 0.5 C 3.65V 0.05 C CUT-OFF) and discharged (CC 0.1 C 2.5V CUT-OFF) at −20° C., and then a discharge capacity was measured. The measured discharge capacity was evaluated as a −20° C. low-temperature discharge capacity.

The −20° C. low-temperature discharge capacity was expressed as a percentage relative to the room-temperature discharge capacity to calculate a −20° C. low-temperature power property (%).

### (4) Evaluation on Capacity Retention (100 Cycles)

The lithium secondary batteries manufactured according to the above-described Examples and Comparative examples were subjected to 100 cycles of charge (CC-CV 0.1 C 0.01V 0.01C CUT-OFF) and discharge (CC 0.1 C 1.5V CUT-OFF) at room temperature (25° C.). A discharge capacity of the 100th cycle and a discharge capacity of the 1st cycle were measured. A 10-minute interphase was included between the cycles.

The discharge capacity of the 100th cycle was expressed as a percentage of the discharge capacity of the 1st cycle and evaluated as a capacity retention.

The measurement and evaluation results are shown in Tables 2 and 3.

The average particle diameters (D50) of the first lithium metal phosphate particles, the second lithium metal phosphate particles and the lithium-transition metal oxide particles, and the contents based on to the total weight of the cathode active material are shown in Table 1.

TABLE 1

| | average particle diameter (D50) (μm) | | | content (wt %) | | |
|---|---|---|---|---|---|---|
| | first | second | | first | second | |
| | lithium | lithium | lithium- | lithium | lithium | lithium- |
| | metal | metal | transition | metal | metal | transition |
| | phosphate | phosphate | metal oxide | phosphate | phosphate | metal oxide |
| | particle | particle | particle | particle | particle | particle |
| Example 1 | 1.5 | 1.1 | 5 | 40 | 40 | 20 |
| Example 2 | 0.62 | 0.61 | 3.5 | 40 | 40 | 20 |
| Example 3 | 1.7 | 1.2 | 4.0 | 40 | 40 | 20 |
| Example 4 | 0.5 | 0.4 | 2 | 40 | 40 | 20 |
| Example 5 | 2.0 | 1.5 | 6 | 40 | 40 | 20 |
| Example 6 | 0.4 | 0.4 | 2 | 40 | 40 | 20 |
| Example 7 | 2.1 | 1.5 | 6 | 40 | 40 | 20 |
| Example 8 | 0.5 | 0.3 | 2 | 40 | 40 | 20 |
| Example 9 | 2.0 | 1.6 | 6 | 40 | 40 | 20 |
| Example 10 | 0.5 | 0.4 | 1.9 | 40 | 40 | 20 |
| Example 11 | 2.0 | 1.5 | 6.1 | 40 | 40 | 20 |
| Example 12 | 1.5 | 1.1 | 5 | 30 | 30 | 40 |
| Example 13 | 1.5 | 1.1 | 5 | 20 | 50 | 30 |
| Example 14 | 1.5 | 1.1 | 5 | 10 | 50 | 40 |
| Example 15 | 1.5 | 1.1 | 5 | 50 | 10 | 40 |
| Example 16 | 1.5 | 1.1 | 5 | 8 | 50 | 42 |
| Example 17 | 1.5 | 1.1 | 5 | 52 | 20 | 28 |
| Example 18 | 1.5 | 1.1 | 5 | 50 | 8 | 42 |
| Example 19 | 1.5 | 1.1 | 5 | 10 | 52 | 38 |
| Example 20 | 1.5 | 1.1 | 5 | 50 | 45 | 5 |
| Example 21 | 1.5 | 1.1 | 5 | 50 | 47 | 3 |
| Example 22 | 1.5 | 1.1 | 11 (secondary | 40 | 40 | 20 |
| | | | particle) | | | |
| Comparative | 1.5 | — | — | 100 | 0 | 0 |
| Example 1 | | | | | | |
| Comparative | — | 1.1 | — | 0 | 100 | 0 |
| Example 2 | | | | | | |
| Comparative | — | — | 5 | 0 | 0 | 100 |
| Example 3 | | | | | | |
| Comparative | 1.5 | 1.1 | — | 50 | 50 | 0 |
| Example 4 | | | | | | |
| Comparative | 1.5 | — | 5 | 70 | 0 | 30 |
| Example 5 | | | | | | |
| Comparative | — | 1.1 | 5 | 0 | 70 | 30 |
| Example 6 | | | | | | |
| Comparative | 1.1 | 1.2 | 5 | 40 | 40 | 20 |
| Example 7 | | | | | | |
| Comparative | 2 | 1.5 | 1.2 | 40 | 40 | 20 |
| Example 8 | | | | | | |
| Comparative | 2 | 1.2 | 1.5 | 40 | 40 | 20 |
| Example 9 | | | | | | |

TABLE 2

| | 1.5 C | 2.0 C | 2.5 C | 3.0 C |
|---|---|---|---|---|
| | discharge | discharge | discharge | discharge |
| | capacity | capacity | capacity | capacity |
| | ratio (%) | ratio (%) | ratio (%) | ratio (%) |
| Example 1 | 99 | 98 | 95 | 93 |
| Example 2 | 98 | 98 | 94 | 92 |
| Example 3 | 99 | 99 | 95 | 94 |
| Example 4 | 98 | 97 | 94 | 92 |
| Example 5 | 98 | 97 | 95 | 93 |
| Example 6 | 98 | 97 | 93 | 92 |
| Example 7 | 98 | 98 | 95 | 93 |
| Example 8 | 98 | 97 | 92 | 91 |
| Example 9 | 99 | 97 | 93 | 92 |
| Example 10 | 95 | 93 | 89 | 87 |
| Example 11 | 94 | 92 | 88 | 85 |
| Example 12 | 99 | 98 | 96 | 94 |
| Example 13 | 99 | 99 | 95 | 94 |
| Example 14 | 97 | 95 | 92 | 91 |
| Example 15 | 98 | 95 | 92 | 90 |
| Example 16 | 96 | 95 | 93 | 91 |
| Example 17 | 97 | 94 | 92 | 91 |
| Example 18 | 93 | 91 | 87 | 86 |
| Example 19 | 94 | 92 | 88 | 85 |
| Example 20 | 97 | 95 | 91 | 90 |
| Example 21 | 95 | 91 | 88 | 86 |
| Example 22 | 99 | 99 | 97 | 95 |
| Comparative | 92 | 91 | 82 | 78 |
| Example 1 | | | | |
| Comparative | 99 | 99 | 73 | 60 |
| Example 2 | | | | |
| Comparative | 98 | 95 | 90 | 81 |
| Example 3 | | | | |
| Comparative | 96 | 89 | 85 | 78 |
| Example 4 | | | | |
| Comparative | 92 | 92 | 88 | 81 |
| Example 5 | | | | |
| Comparative | 98 | 98 | 83 | 81 |
| Example 6 | | | | |
| Comparative | 96 | 95 | 90 | 88 |
| Example 7 | | | | |
| Comparative | 87 | 83 | 78 | 69 |
| Example 8 | | | | |
| Comparative | 88 | 84 | 77 | 70 |
| Example 9 | | | | |

TABLE 3

| | −10° C. low | −20° C. low | capacity |
|---|---|---|---|
| | temperature power | temperature power | retention |
| | property (%) | property (%) | (%, 100 cycles) |
| Example 1 | 94 | 89 | 95 |
| Example 2 | 95 | 88 | 95 |
| Example 3 | 94 | 88 | 96 |
| Example 4 | 93 | 86 | 94 |
| Example 5 | 93 | 87 | 94 |
| Example 6 | 92 | 87 | 89 |
| Example 7 | 92 | 86 | 89 |
| Example 8 | 89 | 85 | 92 |
| Example 9 | 90 | 84 | 92 |
| Example 10 | 91 | 86 | 94 |
| Example 11 | 92 | 88 | 93 |
| Example 12 | 96 | 90 | 95 |
| Example 13 | 95 | 88 | 96 |
| Example 14 | 94 | 88 | 93 |
| Example 15 | 90 | 85 | 92 |
| Example 16 | 92 | 86 | 88 |
| Example 17 | 89 | 82 | 91 |
| Example 18 | 89 | 81 | 88 |
| Example 19 | 92 | 86 | 92 |
| Example 20 | 90 | 83 | 94 |
| Example 21 | 89 | 84 | 94 |
| Example 22 | 91 | 85 | 87 |
| Comparative | 61 | 37 | 81 |
| Example 1 | | | |
| Comparative | 88 | 81 | 81 |
| Example 2 | | | |
| Comparative | 70 | 55 | 76 |
| Example 3 | | | |
| Comparative | 75 | 68 | 83 |
| Example 4 | | | |
| Comparative | 66 | 50 | 78 |
| Example 5 | | | |
| Comparative | 79 | 69 | 79 |
| Example 6 | | | |
| Comparative | 82 | 74 | 84 |
| Example 7 | | | |
| Comparative | 88 | 78 | 80 |
| Example 8 | | | |
| Comparative | 65 | 46 | 82 |
| Example 9 | | | |

Referring to Tables 2 and 3, in Examples where the second lithium metal phosphate particles, the first lithium metal phosphate particles and the lithium-transition metal oxide particles having sequentially increasing average particle diameters were used, the power, low-temperature performance and capacity retention properties were improved compared to those from Comparative Examples.

In Examples 6 and 7 where the average particle diameter (D50) of the first lithium metal phosphate particles was not within a range from 0.5 tm to 2 am, the capacity retention was relatively lowered compared to those from other Examples.

In Examples 8 and 9 where the average particle diameter (D50) of the second lithium metal phosphate particles was not within a range from 0.4 am to 1.5 am, the low-temperature performance was relatively lowered compared to those from the other examples.

In Examples 10 and 11 where the average particle diameter (D50) of the lithium-transition metal oxide particles was not within a range from 2 μm to 6 μm, the power properties were relatively lowered compared to those from other Examples.

In Examples 16 and 17, where the content of the first lithium metal phosphate particles was not within a range from 10 wt % to 50 wt % based on the total weight of the cathode active material, the capacity retention was relatively lowered compared to those from other Examples.

In Examples 18 and 19 where the content of the second lithium metal phosphate particles was not within a range from 10 wt % to 50 wt % based on the total weight of the cathode active material, the power properties and the capacity retention were relatively lowered compared to those from other Examples.

In Examples 16, 18 and 21 where the content of the lithium-transition metal oxide particles was not within a range from 5 wt % to 40 wt % based on the total weight of the cathode active material, the power properties and the capacity retention were relatively lowered compared to those from other Examples.

In Example 22 where the lithium-transition metal oxide particles in the form of the secondary particle were used, the capacity retention was relatively lowered compared to those from other Examples.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A cathode for a secondary battery, comprising:
first lithium metal phosphate particles;
second lithium metal phosphate particles having an average particle diameter (D50) smaller than an average particle diameter (D50) of the first lithium metal phosphate particles and including manganese; and
lithium-transition metal oxide particles having an average particle diameter (D50) larger than the average particle diameter (D50) of the first lithium metal phosphate particles and including nickel.

2. The cathode according to claim 1, wherein the first lithium metal phosphate particles have a shape of a single particle.

3. The cathode according to claim 1, wherein the second lithium metal phosphate particles have a shape of a single particle.

4. The cathode according to claim 1, wherein the lithium-transition metal oxide particles have a shape of a single particle.

5. The cathode according to claim 1, wherein the average particle diameter (D50) of the first lithium metal phosphate particles is in a range from 0.5 μm to 2 μm.

6. The cathode according to claim 1, wherein the average particle diameter (D50) of the second lithium metal phosphate particles is in a range from 0.4 μm to 1.5 μm.

7. The cathode according to claim 1, wherein the average particle diameter (D50) of the lithium-transition metal oxide particles is in a range from 2 μm to 6 μm.

8. The cathode according to claim 1, wherein a content of the first lithium metal phosphate particles is in a range from 10 wt % to 50 wt % based on a total weight of the cathode active material.

9. The cathode according to claim 1, wherein a content of the second lithium metal phosphate particles is in a range from 10 wt % to 50 wt % based on a total weight of the cathode active material.

10. The cathode according to claim 1, wherein a content of the lithium-transition metal oxide particles is in a range from 5 wt % to 40 wt % based on a total weight of the cathode active material.

11. The cathode according to claim 1, wherein the first lithium metal phosphate particles are represented by Chemical Formula 1:
LiₐM1ₓP_{y}O_{4+z} [Chemical Formula 1]
wherein, in Chemical Formula 1, 0.9≤a≤1.2, 0.99≤x≤1.01, 0.9≤y≤1.2, −0.1≤z≤0.1, and M1 includes at least one selected from Fe, Co and Ni.

12. The cathode according to claim 1, wherein the second lithium metal phosphate particles are represented by Chemical Formula 2:
Li_{b}Mn_{c}Fe_{d}PeO_{4+f} [Chemical Formula 2]
wherein, in Chemical Formula 2, 0.9≤b≤1.2, 0.4≤c≤1.0, 0.2≤d≤0.6, 0.9≤e≤1.2, and −0.1≤f≤0.1.

13. The cathode according to claim 1, wherein the lithium-transition metal oxide particles further include cobalt and manganese.

14. The cathode according to claim 13, wherein a molar ratio of nickel based on a total molar number of nickel, cobalt and manganese included in the lithium-transition metal oxide particle is 0.8 or more.

15. A lithium secondary battery, comprising:
a cathode including a cathode active material comprising:
first lithium metal phosphate particles;
second lithium metal phosphate particles having an average particle diameter (D50) smaller than an average particle diameter (D50) of the first lithium metal phosphate particles and including manganese; and
lithium-transition metal oxide particles having an average particle diameter (D50) larger than the average particle diameter (D50) of the first lithium metal phosphate particles and including nickel; and
an anode facing the cathode.

16. The lithium secondary battery according to claim 15, wherein one or more of the first lithium metal phosphate particles, the second lithium metal phosphate particles, or the lithium-transition metal oxide particles have a shape of a single particle.

17. The lithium secondary battery according to claim 1, wherein the average particle diameter (D50) of the first lithium metal phosphate particles is in a range from 0.5 μm to 2 μm.

18. The lithium secondary battery according to claim 1, wherein the average particle diameter (D50) of the second lithium metal phosphate particles is in a range from 0.4 μm to 1.5 μm.

19. The lithium secondary battery according to claim 1, wherein the average particle diameter (D50) of the lithium-transition metal oxide particles is in a range from 2 μm to 6 μm.
